(19) United States
(12) Patent Application Publication
(10) Pub. No.: US 2002/0066175 A1
(43) Pub. Date: Jun. 6, 2002

(54) Method of manufacturing inductor

(76) Inventors: Heng-sheng Huang, Taipei City (TW); Gary Hong, Hsinchu (TW); Dong-Long Lee, Kaohsiung (TW); Meng-Jen Chuang, Tainan (TW)

Correspondence Address: CHARLES C.H. WU & ASSOCIATES, Suite 710, 7700 IRVINE CENTER DRIVE, Irvine, CA, 92618-3043, US

(21) Appl. No.: 09/736,604

(22) Filed: Dec. 13, 2000

(30) Foreign Application Priority Data
Dec. 4, 2000 (TW) 89125788

(51) Int. Cl. H01F 7/06

(52) U.S. Cl. 29/602.1; 336/200

(57) ABSTRACT

A method of manufacturing an inductor. A substrate is provided and then a plurality of linear-shaped first metallic layers is formed over the substrate. A first dielectric layer having a planar upper surface is over the substrate and the first metallic layers. A second metallic layer having a high magnetic conductance coefficient is embedded within the first metallic layer. A second dielectric layer is formed over the first dielectric layer and the second metallic layer. Via openings are formed in the first and the second dielectric layer directly above each end of each linear-shaped first metallic layer. Conductive material is deposited into the via openings to form plugs. A plurality of linear-shaped third metallic layers is formed so that the first metallic layer, the plug and the third metallic layer together form a spiral path. A dual damascene process may also be used to form the plugs and the third metallic layers.

### CROSS-REFERENCE TO RELATED APPLICATION

This application claims the priority benefit of Taiwan application serial no. 89125788, filed Dec. 4, 2000.

### BACKGROUND OF THE INVENTION

1. Field of Invention

The present invention relates to a method of manufacturing inductor. More particularly, the present invention relates to a method of manufacturing an inductor such that a high magnetic conductance coefficient material is also embedded inside the inductor.

2. Description of Related Art

Following the rapid development of communication industry, cable connection has mostly been replaced by wireless communication. Furthermore, in wireless communication, the upcoming trend is towards the utilization of higher frequency bandwidth. Consequently, high-frequency devices have become indispensable components in communication equipment. Because a high frequency device must have small and precise inductance and small inductor coil resistance at high resonance frequencies, cost for producing high frequency inductor is greatly increased.

FIGS. 1 through 5 are schematic cross-sectional views showing the progression of steps for producing a conventional spiral-shaped inductor coil. First, as shown in FIG. 1, a cut ceramic or glass substrate board 100 is provided. Conducting film is formed on each side of the substrate 100. Photolithographic and etching processes are conducted to pattern the conductive film on the substrate 100. Electrode leads 102a are formed on one side of the substrate 100. On the other hand, a spiral-shaped coil 104 and some other electrode leads 102b are formed on the other surface or the main surface of the substrate 100.

As shown in FIG. 2, due to the need for a low resistance in a high-frequency inductor, an electroplated layer 106 is formed over the electrode leads 102a, 102b and the spiral-shaped coil 104. The electroplated layer 106 will increase the thickness of conductive layer and hence lowering corresponding resistance.

As shown in FIG. 3, an insulation layer 108 is formed over substrate 100 outside the electrode lead 102b occupied regions. In addition, the electroplated layer 106 above the spiral-shaped coil 104 is also covered by the insulation layer 108. An opening 110 is reserved in the insulation layer 108 at the central position of the spiral-shaped coil 104 for the subsequent formation of a connective film to an electrode lead.

As shown in FIG. 4, a second conductive film 112 is formed so that the center of the spiral-shaped coil 104 is electrically connected to the electrode lead 102b. An electroplated layer 114 is formed over the conductive film 112. Similarly, the purpose of having the electroplated layer 114 is to increase thickness of a conductive layer and lower resistance. A cap protective layer 116 is formed over the substrate 100 outside the electrode lead 102b occupied regions so that the high-frequency inductor is more reliable.

As shown in FIG. 5, the substrate board 100 is dissected into a plurality of unit boards. After dissection, electrode connection pads 118 are formed on each side of a unit board for connecting with the electrode leads 102a and 102b respectively. Finally, an electroplated interface layer 120 is formed enclosing the electrode connection pads 118 and the electrode leads 102a and 102b.

In the aforementioned spiral-coil inductor production process, inductance of the inductor is increased by spiraling the coils outward in the same plane. Hence, aside from the innermost coil, other coils can interfere with each other and result in a smaller inductance contrary to what is intended. Moreover, a larger the number of outer turns will lead to a greater resistance. Consequently, the Q value of the inductor will become smaller.

### SUMMARY OF THE INVENTION

Accordingly, one object of the present invention is to provide a method of manufacturing an inductor such that the spiral-shaped coil of the inductor is distributed in several layers. Hence, mutual interference caused by forming a multi-coil inductor in a single layer is prevented and the Q value of an inductor is increased.

A second object of the invention is to provide a method of manufacturing an inductor that includes the embedding of a high magnetic conductance coefficient material inside the inductor so that an inductor having a closed magnetic loop is produced.

A third object of the invention is to provide a method of manufacturing an inductor such that the entire inductor structure is formed inside a substrate board. With the formation of built-in inductors, inductors no longer occupy the surface of a chip. Ultimately, more devices can be fabricated on a silicon chip.

To achieve these and other advantages and in accordance with the purpose of the invention, as embodied and broadly described herein, the invention provides a method of manufacturing an inductor. A substrate is provided. A plurality of linear-shaped first metallic layers is formed over the substrate. A first dielectric layer having a planar upper surface is over the substrate and the first metallic layers. A second metallic layer having a high magnetic conductance coefficient is embedded within the first metallic layer. A second dielectric layer is formed over the first dielectric layer and the second metallic layer. Via openings are formed in the first and the second dielectric layer directly above each end of each linear-shaped first metallic layer. Conductive material is deposited into the via openings to form plugs. A plurality of linear-shaped third metallic layers is formed so that the first metallic layer, the plug and the third metallic layer together form a spiral path. A dual damascene process may be used to form the plugs and the third metallic layer.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1 through 5 are schematic cross-sectional views showing the progression of steps for producing a conventional spiral-shaped inductor coil;

FIGS. 6 through 9 are schematic perspective views showing the progression of steps for producing an inductor according to one preferred embodiment of this invention; and

FIG. 10 is a schematic cross-sectional view showing a dual damascene process for forming a third metallic layer and a via opening simultaneously above a substrate according to this invention.

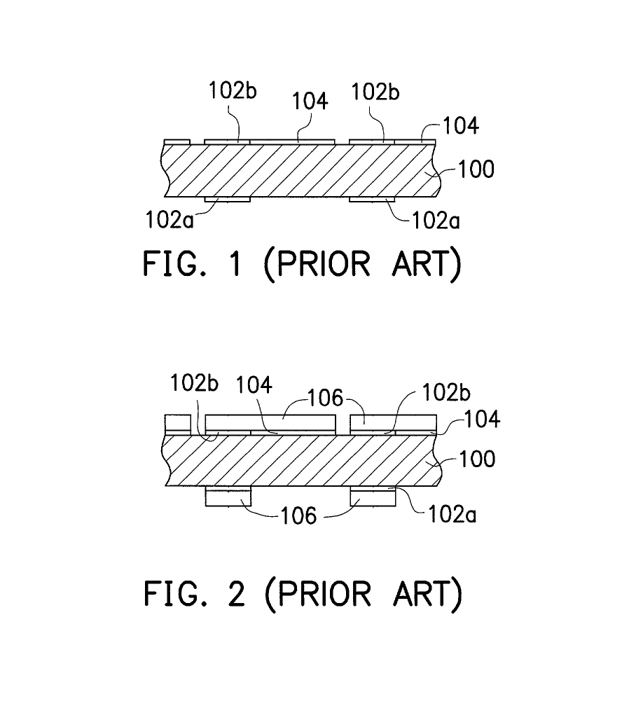

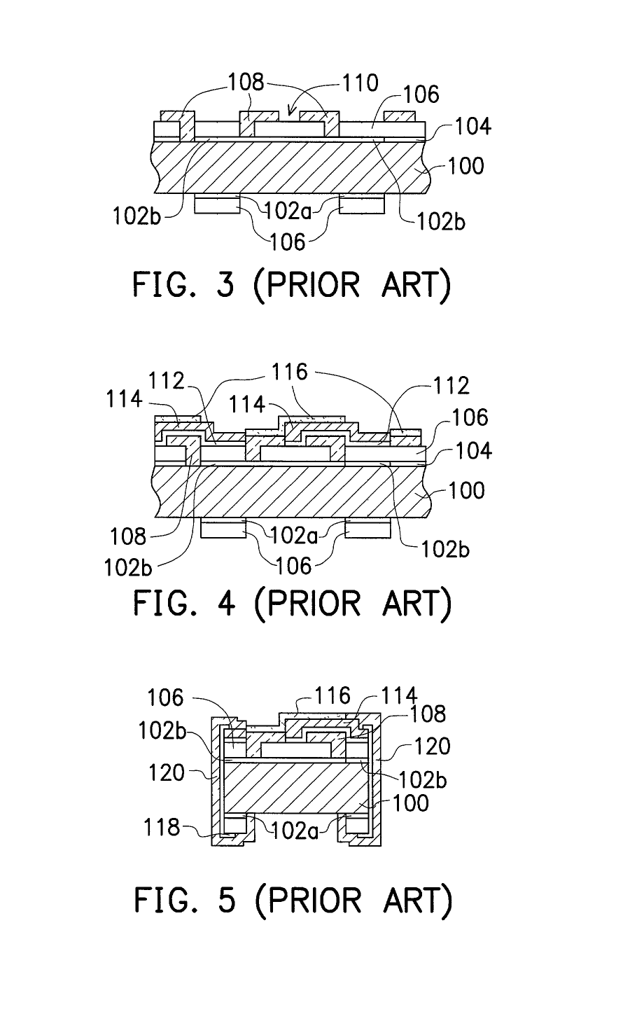

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

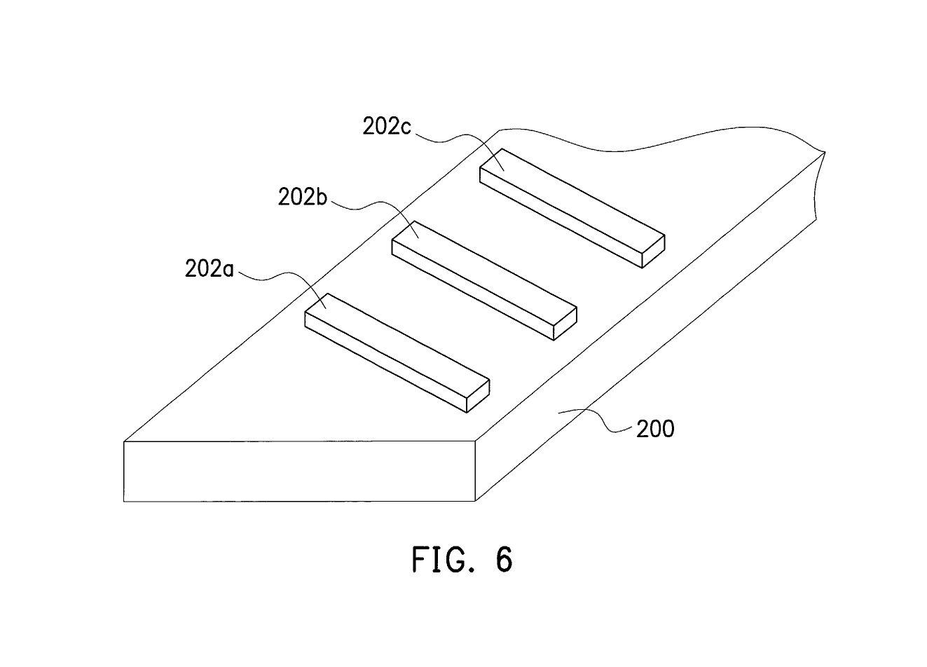

FIGS. 6 through 9 are schematic perspective views showing the progression of steps for producing an inductor according to one preferred embodiment of this invention. First, as shown in FIG. 6, a substrate 200 is provided. A metallic layer is formed over the substrate 200. The metallic layer can be a copper layer formed, for example, by sputtering. Photolithographic and etching processes are sequentially conducted to pattern the metallic layer. For example, the metallic layer is patterned into a plurality of first metallic layers 202a, 202b and 202c that are linear in shape and parallel to each other. In fact, each of the first metallic layers 202a, 202b and 202c constitutes a part of the spiral-shaped inductor coil structure.

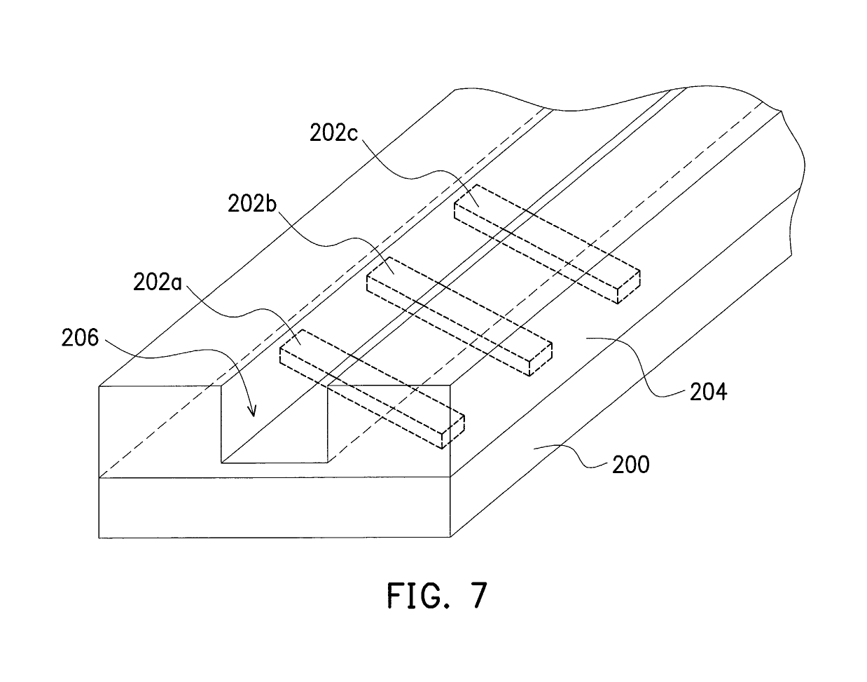

As shown in FIG. 7, a first dielectric layer 204 having a planar upper surface is formed over the linear-shaped first metallic layer 202a, 202b, 202c and the substrate 200. The first dielectric layer 204 can be a silicon dioxide layer formed, for example, by chemical vapor deposition (CVD). Photolithographic and etching processes are sequentially conducted to form a trench 206 in the first dielectric layer 204. The trench 206 exposes a portion of the first metallic layers 202a, 202b and 202c. The trench 206 is formed, for example, using an etchant having high etching selectivity between the first dielectric layer 204 and the first metallic layers 202a, 202b and 202c. Hence, after forming the trench 206, over-etching of the first metallic layers 202a, 202b and 202c will not occur.

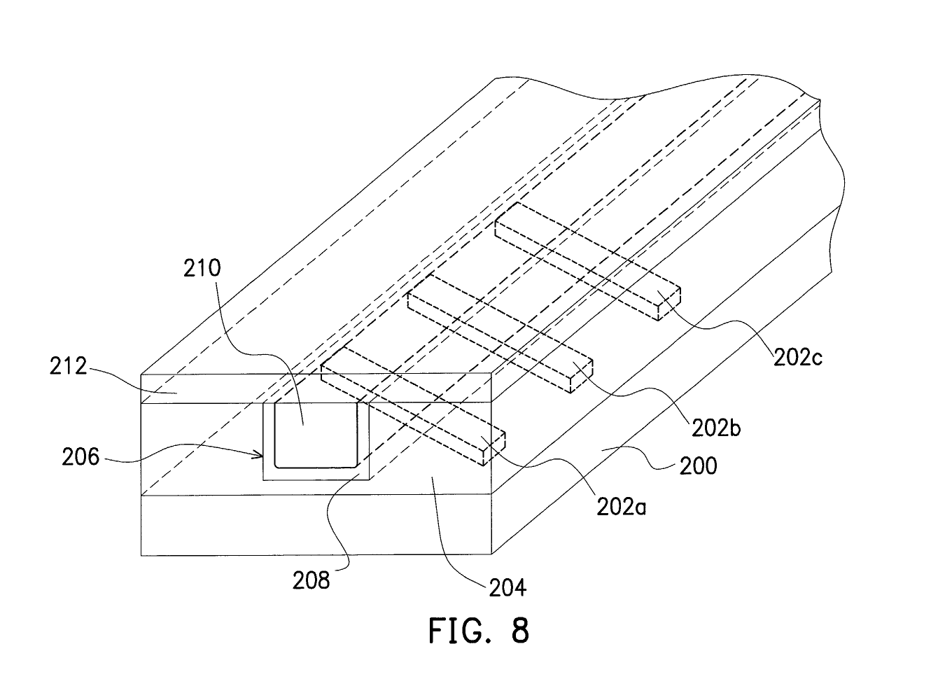

As shown in FIG. 8, a second dielectric layer 208 is formed on the sidewalls and the bottom of the trench 106 as well as the upper surface of the dielectric layer 204. The second dielectric layer 208 can be a conformal silicon dioxide layer formed, for example, by chemical vapor deposition. A chemical-mechanical polishing (CMP) operation is conducted to polish the second dielectric layer 208 outside the trench 206 until the first dielectric layer 204 is exposed. Thereafter, a second metallic layer 210 is formed over the first dielectric layer 204 and the second dielectric layer 208, completely filling the trench 206. The second metallic layer 210 can be a copper layer formed, for example, by sputtering. In addition, the second metallic layer 210 can be formed using a metal that has a high magnetic conductance coefficient. The second metallic layer 210 outside the trench 206 region is polished until the first dielectric layer 204 is exposed. After polishing the second metallic layer 210, the second metallic layer 210 is effectively embedded within the first dielectric layer 204. A third dielectric layer 212 is formed over the first dielectric layer 204, the second dielectric layer 208 and the second metallic layer 210. The third dielectric layer can be a silicon dioxide layer formed, for example, by chemical vapor deposition.

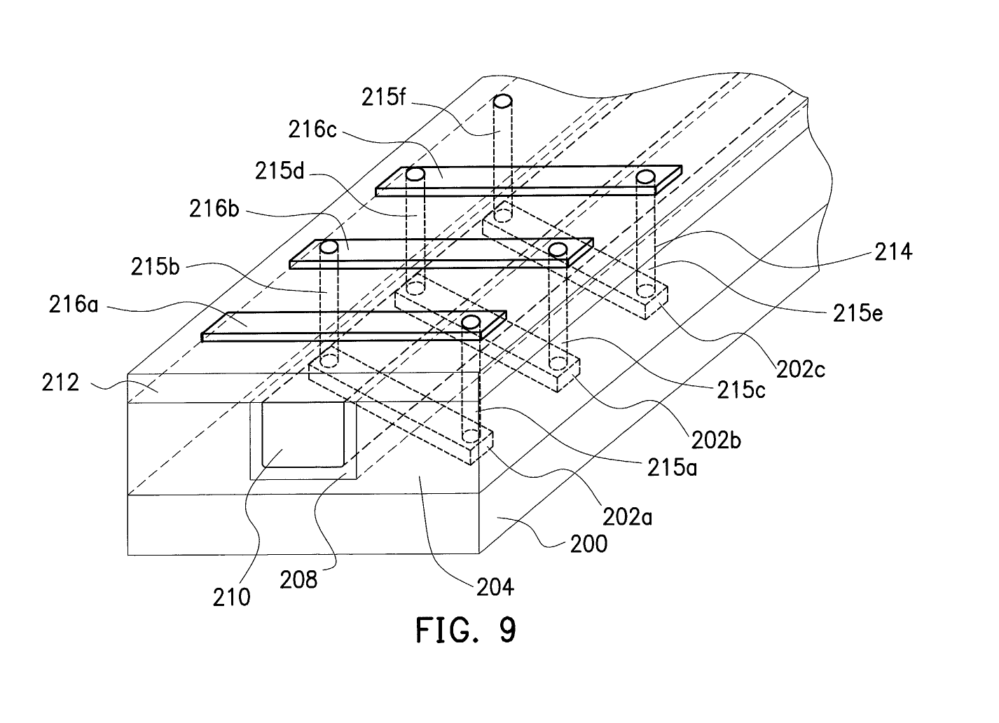

As shown in FIG. 9, a plurality of via openings 214 are formed in the third dielectric layer 212 and the first dielectric layer 204. The via openings 214 are formed in locations corresponding to the ends of the first metallic layers 202a, 202b and 202c. Conductive material is deposited into the via openings 214 to form a plurality of plugs 215a, 215b, 215c, 215d, 215e and 215f. A plurality of metallic layers 216a, 216b and 216c is formed over the third dielectric layer 212. The third metallic layers 216a, 216b and 216c have a linear structure and are parallel to each other. Similarly, the third metallic layers 216a, 216 and 216c are formed by conducting photolithographic and etching processes in sequence.

The third metallic layer 216a, the plug 215a, the first metallic layer 202a, the plug 215b, the third metallic layer 216b, the plug 215c, the first metallic layer 202b, the plug 215d, the third metallic layer 216c, the plug 215e, the first metallic layer 202c and the plug 215f together form a spiral-shaped coil as shown in FIG. 9. Since each turn in the spiral-shaped coil is on a different plane, problem caused by mutual interference across different turns is minimized. In addition, the spiral-shaped coil is centered upon the second metallic layer 210, which is made from a material having a high magnetic conductance coefficient. With a high magnetic conductance coefficient material forming the core of the spiral-shaped coil, an effectively closed magnetic loop is formed.

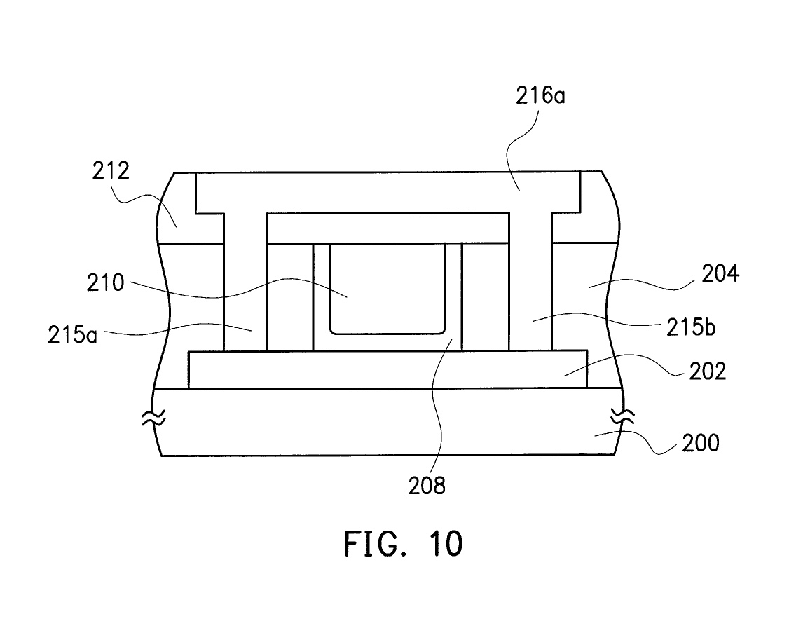

FIG. 10 is a schematic cross-sectional view showing a dual damascene process for forming a third metallic layer and a via opening simultaneously above a substrate according to this invention. The fabrication steps according to this invention can be further simplified by utilizing a dual damascene process to form the linear-shaped third metallic layer 216a and the plugs 215a and 215b at the same time (the third metallic layer 216b, the plugs 215c and 215d, and the third metallic layer 216c, the plugs 215d and 215f are not shown).

In summary, major advantages of this invention includes:

1. The spiral-shaped coil produced by the combination of a plurality of linear first metallic layer, plugs and a plurality of linear third metallic layers causes each turn of the coil to be on a different plane. Hence, mutual interference between different turns in the same coil is minimized.

2. Since the spiral-shaped coil is embedded within a substrate instead of a spiraling out coil on a single layer over the substrate, high-density, high inductance inductor coils can be formed.

3. The spiral-shaped coil and the high magnetic conductance coefficient material in the core effectively produce a close loop magnetic circuit.

4. Unlike the conventional fabrication process, no spiral-shaped coil, conductive film and electroplated interface layer need to be formed in this invention. Hence, processing step is very much simplified. Moreover, the number of turns in the coil can be increased or decreased according to design so that higher inductance and higher Q value can easily be attained.

5. The inductor can be embedded anywhere inside a silicon wafer. The inductor is placed above a substrate or on any other device. The in-built capacity not only facilitates the integration of an inductor within a chip, but also renders the miniaturization of integrated circuit easier.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of manufacturing an inductor, comprising the steps of:
providing a substrate;
forming a plurality of linear-shaped first metallic layers over the substrate;
forming a first dielectric layer over the first metallic layers and the substrate;
forming a second metallic layer embedded within the first dielectric layer;
forming a second dielectric layer over the first dielectric layer and the second metallic layer;
forming a plurality of via opening in the first dielectric layer and the second dielectric layer above the ends of the linear-shaped first metallic layers so that the ends of the first metallic layers are exposed;
depositing conductive material into the via openings to form a plurality of plugs; and
forming a plurality of linear-shaped third metallic layers over the second dielectric layer and the plugs.

2. The method of claim 1, wherein the linear-shaped first metallic layers, the plugs and the linear-shaped third metallic layers together form a spiral-shaped coil.

3. The method of claim 1, wherein the step of forming the second metallic layers further includes the sub-steps of:
removing a portion of the first dielectric layer to form a trench;
forming a third dielectric layer over the trench interior and above the first dielectric layer;
performing a chemical-mechanical polishing to remove the third dielectric layer outside the trench region;
forming a second metallic layer that completely fills the trench; and
performing a chemical-mechanical polishing to remove the second metallic layer outside the trench region.

4. The method of claim 3, wherein the step of forming the third dielectric layer includes chemical vapor deposition.

5. A method of manufacturing an inductor, comprising the steps of:
providing a substrate;
forming a plurality of linear-shaped first metallic layers over the substrate;
forming a first dielectric layer over the first metallic layers and the substrate;
forming a second metallic layer embedded within the first dielectric layer;
forming a second dielectric layer over the first dielectric layer and the second metallic layer; and
performing a dual damascene process to form a plurality of linear-shaped third metallic layer and a plurality of plugs in the first dielectric layer and the second dielectric layer.

6. The method of claim 5, wherein the linear-shaped first metallic layers, the plugs and the linear-shaped third metallic layers together form a spiral-shaped coil.

7. The method of claim 5, wherein the step of forming the second metallic layers further includes the sub-steps of:
removing a portion of the first dielectric layer to form a trench;
forming a third dielectric layer over the trench interior and above the first dielectric layer;
performing a chemical-mechanical polishing to remove the third dielectric layer outside the trench region;
forming a second metallic layer that completely fills the trench; and
performing a chemical-mechanical polishing to remove the second metallic layer outside the trench region.

8. The method of claim 7, wherein the step of forming the third dielectric layer includes chemical vapor deposition.
